(19) United States
(12) Patent Application Publication
(10) Pub. No.: US 2011/0094363 A1
(43) Pub. Date: Apr. 28, 2011

(54) Ceramic cutting tool with an edge area, method for the production and use thereon

(76) Inventors: Wolfgang Hintze, Hamburg (DE); Gerold Schneider, Hamburg (DE); Arndt Püschel, Hamburg (DE); Nils Claussen, Rosengarten (DE); Marie-Helene Berger, Viry-Chatillon (FR); Christian Nedess, Buchholz i.d.N. (DE)

(21) Appl. No.: 10/542,479

(22) PCT Filed: Jan. 15, 2004
(86) PCT No.: PCT/EP2004/000243

§ 371 Date: Mar. 19, 2007

(30) Foreign Application Priority Data
Jan. 17, 2003 (DE) 203 00 823.5
May 14, 2003 (DE) 203 07 478.5

(51) Int. Cl. B32B 18/00; B24D 3/34; C04B 35/10; C04B 35/117; B32B 3/02; B26D 1/12

(52) U.S. Cl. 83/651; 51/307; 51/309; 428/336; 428/216; 428/325

(57) ABSTRACT

A ceramic cutting tool configured as multiphase ceramic with an improved resistance to wear of the edge area or edge layer consists of a base ceramic and of a sacrificial phase as well as eventually additives and primary hard material phases and an eventually multilayered edge area or edge layer resistant to wear, hard, not deposited made of at least one hard material phase, whereby the edge area is intimately intergrown with the starting ceramic and which is formed by aging the starting ceramic in a defined atmosphere.

### FIELD OF APPLICATION

This invention relates to a ceramic cutting tool or to a cutting ceramic with an edge area or an edge layer with an improved capacity of resistance to wear, viscosity, strength and hardness, a method for the manufacturing and use thereof.

Cutting ceramics are naturally hard materials on oxyde or nitride base. Oxyde ceramics are differentiated depending on their composition in so-called white oxyde ceramic kinds on the base of corundum (Al₂O₃) with additions, mainly zirconium oxyde (ZrO2) and the so-called black mixed ceramics with relatively high parts of titanium carbide or titanium carbonitride. The manufacturing thereof takes place by sintering, high-temperature isostatic pressing or high-temperature pressing at temperatures of 1500° to 2000° C. The hardness of these materials heavily falls off only at higher temperatures. Because of their high resistance to wear, their low tendency to diffusion and their resistance to oxidation, oxyde ceramics make very high cutting speeds possible.

Ceramic honeycombs made of a primary structure and of an outer edge layer are known by the DE 41 19 705. These ceramic honeycombs have a gastight outer layer which is made completely of ceramic resistant to wear, in particular of oxydes, carbides, nitrides and/or borides of aluminium and zirconium, an inner structure made of metallic and ceramic phases (cermet) as well as an intermediate layer which connects the ceramic outer layer with the inner structure and forms a continuous transition from the outer layer to the metal containing inner structure. This ceramic body is supposed to be characterized by a high strength, resistance to wear as well as a high resistance to thermal shock and to have an outer layer which does not tend to spalling.

The grading of hard metals is known as well; it makes possible a defined variation of the structural, thermal and functional properties of hard metals (Lengauer, W.; Dreyer, K.: Functionally graded hard metals, Journal of Alloys and Compounds 338 (2002) 194-212, as well as Ucakar, V.; Kral, C.; Dreyer, K.; Lengauer, W.: Near-surface microstructural modification of (Ti,W)(C,N)-based compacts with nitrogen, 15^{th} International Plansee Seminar, Eds. Kenringer, G.; Rödhammer, P. and Wildner, H.: Plansee Holding AG, Reuttle (2001) vol. 2). An improvement of the service properties of hard metal and ceramic cutting materials can be realized by coatings. Depending on the priority for the application, the hardness, the coefficient of friction as well as the resistance to oxydation can be varied (DE 197 099 80 C1 and DE 36 08 734 C1). Furthermore, whisker reinforced ceramic cutting tools are known (EP 0 861 219).

Cutting ceramics made of AL₂O₃ and TiC (mixed ceramics) are known by the U.S. Pat. No. 3,580,708.

The disadvantage for the manufacturing of known cutting ceramics is the use of pure, preferably high-purity starting materials, for example oxygen-free TiC, high sintering temperatures are necessary too for the manufacturing of cutting ceramics according to the prior art which require a high expenditure of energy and thus result in too high manufacturing costs of known mixed ceramics. A further disadvantage consists in a resistance to wear which is still to be improved which can be increased by coatings as for hard metals. Due to the processing technologies used here, starting from the material to be coated to a layer material, there is an abrupt (non graded) transition of material which makes possible only a weak layer adhesion and which can result in spalling during the use. Moreover, for increasing layer thickness (multilayered too), there appears a rounding of the cutting edge so that the cutting edge geometry which has been achieved beforehand with many efforts, most with diamond tools, is getting lost. Furthermore, the known coating methods require a costly charging, this being due to the process.

### AIM, SOLUTION, ADVANTAGE

The aim of this invention is to increase the resistance to wear of ceramic or mixed ceramic cutting materials and to achieve costs of manufacturing as low as possible. In particular for the layer treatment of hardened steels and the processing of materials for casting, the functional behaviour of the cutting ceramic should be improved. Furthermore, an edge area or edge layer which does not tend to spalling should be achieved for which the cutting edge geometry remains maintained, in particular sharp cutting edges should not be rounded. Moreover, the charging of the cutting plates should be simplified for the edge area manufacturing/coating.

This aim is achieved for a ceramic cutting tool with the characteristics indicated in claim 1 and with a method according to claim 14 for manufacturing the ceramic cutting tool.

The ceramic cutting tool according to the invention is a multi-phase ceramic (starting ceramic) which is made of a base ceramic and of a sacrificial phase as well as eventually additives and primary hard material phases and an eventually multilayered edge area or edge layer resistant to wear, hard, not precipitated made of at least one hard material phase, whereby the edge area is intimately intergrown with the starting ceramic and which is formed by aging the starting ceramic in a defined atmosphere.

The advantages of the multiphase cutting ceramic according to the invention consist in the use of cheap raw materials and low sintering temperatures due to the process. For producing the edge layer, the ceramic body is subject to a temperature treatment, preferably pressure-assisted after the hard machining for producing the cutting edge geometry which takes place in a reducing atmosphere and/or in a reducing sintering bed, whereby the characteristic elements of the layer material, which are specified more exactly below, are not made available by secondary sources. This being, the charging of the cutting bodies takes place quite simply. The edge area is ideally connected with the structure of the multiphase cutting ceramic due to diffusion and rearrangement processes so that there is a low tendency to spalling. Due to the hard material edge layers produced according to the invention, the wear and service properties of the cutting ceramic are improved (see FIG. 7). In a further alternative for the method, the cutting edge geometry is produced in the raw state of the ceramic cutting body in order to realize during the sintering simultaneously the production of an edge area and thus to further reduce the manufacturing costs. Due to a favourable composition of the multiphase cutting ceramic, the production of multilayer coatings is possible for the further advantageous configuration of the cutting tool with respect to the improvement of its wear, friction and service properties.

The multiphase cutting tool according to the invention consists of a starting ceramic which is composed of a base ceramic with 50% by volume at the most of one or several sacrificial phases and with at the most 40% by volume additives and with at the most 50% by volume of one or several primary hard material phases as well as of an edge area (or an edge layer or an edge extent). This being, the edge area is intimately intergrown with the base material/starting material. The edge area does not have a percentage of starting ceramic, in particular of base ceramic, or has a considerably reduced one and is manufactured after the usually last manufacturing step, the hard machining of ceramic cutting plates by a subsequent eventually pressure-assisted temperature treatment in a reducing atmosphere.

The base ceramic is a ceramic basing on one or several metallic or semimetallic compound(s) with oxygen and/or nitrogen based ceramic, preferably aluminium oxyde.

The sacrificial phase is the oxyde and/or oxygen containing compound of carbon and/or nitrogen and/or boron, of one or several characteristic elements, especially titanium oxyde carbide and/or titanium oxycarbonitride.

The characteristic elements are preferably elements of the 3^{rd} or the 4^{th} or the 5^{th} period, of the subsidiary group IV or V or VI of the system of the period of the elements and/or boron and/or silicium, preferably titanium and/or zirconium and/or vanadium and/or tungsten and/or boron and/or silicium, especially titanium and/or zirconium.

Additives designate wished or tolerated but also compulsory existing additions in form of additives, sintering aids and impurities which are contained in the initial powders, which are mixed to the powder packing or which are added as a result of the powder preparation or which develop due to abrasion, whereby the matter is preferably of ZrO₂.

The primary hard material phase is the carbide and/or nitride and/or boride and/or carbonitride and/or carboboride and/or boron nitride and/or carboboron nitride of one or of several characteristic elements, preferably titanium carbide and/or titanium carbonitride, especially titanium carbide.

The edge area consists of one or of several hard material phase(s), the carbide and/or nitride and/or boride and/or the mixtures thereof of one or of several characteristic elements, is structured in one or several layers and, compared to the basic material, has no or a considerably reduced percentage of base ceramic.

The starting ceramic used for the ceramic cutting tool is made available by an aluminothermic manufacturing and/or conventional pressureless, eventually vacuum-assisted sintering and/or hot isostatic pressing and/or hot pressing and/or microwave sintering and/or laser sintering in a reducing atmosphere.

The multiphase ceramic consists of at least two characteristic structure constituents (phases), preferably Al₂O₃ (as base ceramic) and a sacrificial phase, preferably an oxide and/or oxycarbide and/or oxynitride and/or oxyboride and/or oxycarbonitride and/or oxycarboboride and/or oxyboron nitride and/or oxycarboboron nitride, especially an oxycarbide and/or oxynitride and/or oxycarbonitride, whereby the Al₂O₃ phase, preferably consists of Al₂O₃ without impurities, especially of high-purity Al₂O₃.

The multiphase ceramic preferably based on Al₂O₃ possesses a structure which has a mean grain size between 100 nm to 10 μm, preferably between 300 nm and 5 μm, especially between 500 nm and 3 μm.

The edge area of the cutting tool has a thickness between 0.1 μm and 20 μm, preferably between 0.5 μm and 8 μm, especially between 1 μm and 4 μm; with the basic material, a junction area with a thickness of 50 nm to 5 μm is formed.

The sacrificial phase consists in particular of titanium oxycarbide and/or titanium oxynitride and/or titanium oxycarbonitride and has, in a preferred embodiment, a lower nanohardness than Al₂O₃, at the most 26 GPa (measured with Berkovichindenter, at 3 mN), preferably at the most 25 GPa, exactly 23 GPa. The edge area of the ceramic cutting tool or of the cutting ceramic consists in particular of titanium carbide and/or titanium carbonitride and has a higher nanohardness than Al₂O₃, preferably in the range of 27 GPa to 35 GPa (measured with Berkovichindenter, at 3 mN), in particular 29 GPa to 32 GPa. A further embodiment of the ceramic cutting tool provides that the edge area, manufactured as a coating or a coating schema (multilayer coating of the same and/or of different materials) or completed by means of chemical and/or physical precipitation, influences the properties of the cutting tool, preferably changes the hardness and the resistance to wear, especially improves the service properties.

The cutting ceramic according to the invention is used among others as chip removing tool for machining metallic materials with a hardness higher than 50 HRC, preferably hardened steel and/or materials for casting. The cutting edge of the cutting ceramic is formed by a first face and a free face at the junction of the first face and of the free face; it is preferably chamferred.

A junction area of between 50 nm and 5 μm is formed between the edge area and the starting material, junction area in which they are intimately intergrown.

The structure of the multiphase starting ceramic has a mean grain size between 100 nm and 10 μm, preferably between 300 nm and 5 μm, in particular between 500 nm and 3 μm.

The sacrificial phase consists of titanium oxycarbide and has a lower nanohardness (measured with Berkovichindenter, at 3 mN) than Al₂O₃, at least 26 GPa, preferably 23 GPa.

The edge area or edge layer mainly contains titanium carbide which has a higher nanohardness (measured with Berkovichindenter, at 3 mN) than Al₂O₃, preferably between 27 GPa to 35 GPa, in particular 29 GPa to 32 GPa.

An one-layer or multilayer coating is applied onto the edge area or edge area by means of physical and/or chemical precipitation of the same and/or of different materials, whereby the service properties of the cutting tool are improved.

The method according to the invention for manufacturing the cutting tool comprises according to a first embodiment the following steps:
According to known powder metallurgical methods, the starting powders are processed, green bodies manufactured and compacted to semifinished products with known sintering methods;
Manufacturing of the wished cutting edge geometry, preferably by grinding, in particular of the first face, free face and protection chamfer;
Production of edge areas or edge layers after the hard machining of the cutting tool by subsequent aging in a defined atmosphere.

According to a second embodiment, the method comprises the following steps:
According to known powder metallurgical methods, the starting powders are processed and green bodies manufactured;
Manufacturing of the wished cutting edge geometry or phasology in green state by taking into account the sintering shrinking, preferably by grinding, in particular of the first face, free face and protection chamfer;
Sintering with aging of the machined green body and simultaneous production of edge areas or edge layers by known methods in a defined atmosphere.

A third embodiment of the method according to the invention for manufacturing the ceramic cutting body with an improved resistance to wear, viscosity, strength and hardness of the edge are or edge layer consists in that a multiphase starting ceramic/starting material is made available which consists of a a sacrificial phase of at the most 50% by volume and at the most 40% by volume additives and at the most 50% by volume primary hard material phase and the rest base ceramic, whereby
after the powder processing a green body manufacturing takes place with a subsequent reaction sintering,
then a hard treatment of the sintered ceramic body, preferably by grinding, in particular of the first face, protection chamfer and free face, is carried out and
after the hard treatment of the ceramic cutting body a thermal, preferably thermally pressure-assisted aging in a reducing, preferably carbon and/or nitrogen containing atmosphere, specially a high-pressure isostatic pressing, preferably at 1550°-1650° C. or at other appropriate temperatures for producing an edge area or edge layer on a multiphase, preferably on Al₂O₃ based ceramic.

A fourth embodiment of the method for manufacturing a cutting tool with an improved resistance to wear of the edge area or edge layer comprises the following steps:
After the known powder metallurgical methods, the starting powder is processed and green bodies are manufactured; preferably the composition of the starting powders is chosen with respect to a reaction sintering, in particular with respect to an aluminothermic reaction sintering;
Presintering of the green body preferably below the foreseen maximal sintering temperature, preferably in the temperature range of 200° and 1500° C., in particular 300 and 800° C., preferably at a pressure between 0.001 mbar and 1 bar, in particular between 0.01 mbar and 100 mbar, preferably by using a rinsing gas, in particular argon, preferably in a defined atmosphere, preferably in a reducing, in particular in carbon containing atmosphere.
Machining of the presintered cutting body for manufacturing the wished cutting edge geometry, preferably by grinding, in particular of the free face and/or the protection chamfer and/or the first face;
Second sintering or dense sintering of the presintered and hard machined semifinished product with simultaneous or subsequent aging in a defined atmosphere for producing an edge area or edge layer.

The sintering or presintering and/or the second sintering of the ceramic cutting body takes place by means of aluminothermic or reactive or conventional depressurized, eventually vacuum-assisted sintering and/or by means of high-temperature isostatic pressing and/or hot pressing and/or microwave sintering and/or laser sintering. The edge are is formed by thermal, eventually pressure-assisted aging or sintering of the cutting body. The edge area can also be formed by aging in a defined, preferably reducing, in particular in a carbon containing atmosphere, preferably in a furnace with carbon or carbon containing heating elements. Furthermore, the formation of the edge area by aging in a defined, preferably reducing, in particular in a nitrogen containing atmosphere is possible. Preferably the edge area is formed by aging at maximal temperatures between 1000° C. and 2500° C., preferably between 1300° C. and 2000° C., in particular between 1550° and 1650° C. and by thermal or thermally pressure-assisted aging at a pressure of between 0.001 mbar and 4000 bar, preferably at a pressure between 100 bar and 3000 bar. Preferably, the edge area is formed by aging by using rinsing and/or pressure gas, preferably argon and/or nitrogen, in particular argon. The edge are is furthermore formed by aging at stay-down times between 1 min and 300 min, preferably between 5 min and 180 min, in particular between 10 min and 60 min, at a pressure chosen according to claim 23 and/or at a temperature chosen according to claim 22. This being, the aging takes place in a sintering bed, preferably in a carbon containing sintering bed. Due to the aging, an externally discoloured edge area, preferably an at the surface gold yellow edge area is produced.

Moreover, the invention foresees the use of a ceramic cutting tool with an improved resistance to wear, viscosity, strength and hardness of the edge areas or edge layer as part according to any of the claims 1 to 13 in apparatus and mechanical engineering, in particular as cutting plate.

Because of the configuration according to the invention, a ceramic cutting tool is created which has a high resistance to wear, viscosity, strength and hardness, in particular in the edge area or edge layer. The resistance to wear of such mixed ceramic cutting materials is increased, whereby the costs of manufacturing are as low as possible. In particular for the finish machining of hardened steels and the machining of materials for casting, the functional behaviour of the cutting ceramic is improved. Furthermore, a sharp cutting edge and an edge area or edge layer which does not tend to spalling is achieved. Moreover, the charging of the cutting plates for the edge area manufacturing/coating is simplified.

Due to the phase existence (sacrificial phase) of an easily to realize furnace atmosphere as well as a simple charging, the edge area manufacturing/coating is simplified.

The method according to the invention offers the possibility or the cutting bodies according to the invention offer the advantage that the hardness/wear and viscosity/flexural strength properties of the base material and the edge layer can be optimized separately. So, for example the free face wear which determines the endurance for the hard finish machining can be reduced without reducing the viscosity.

### SHORT DESCRIPTION OF THE DRAWINGS

The invention will be explained below by means of embodiments in connection with the figures.

FIG. 1 shows a schematic view of the composition as well as of the structure of a ceramic cutting body with a particularly configured edge area.

FIG. 2 shows a scanning electron microscope representation of the structure of a ceramic cutting body with a particularly configured edge area.

FIG. 3 shows an embodiment for the course of the process for manufacturing a ceramic cutting body in a schematic representation with process parameters.

FIG. 4 shows a more general schematic representation of the embodiment represented in FIG. 3 of the courses of process for the manufacturing of a ceramic cutting body.

FIG. 5 shows scanning electron microscope shots of an oblique polish of the edge area of a ceramic cutting body with a basic structure, a hard material layer (TiC), a junction area (hard material layer-basic material) and cutting body surface (posthip surface).

FIG. 6 shows a scanning electron microscope representation of the structure of a ceramic cutting body with an element mapping on a cross-section polish of a cutting body with a particularly configured edge area.

FIG. 7 shows the wear behaviour of ceramic cutting bodies compared with the prior art.

### DETAILED DESCRIPTION OF THE INVENTION AND BEST WAY FOR CARRYING OUT THE INVENTION

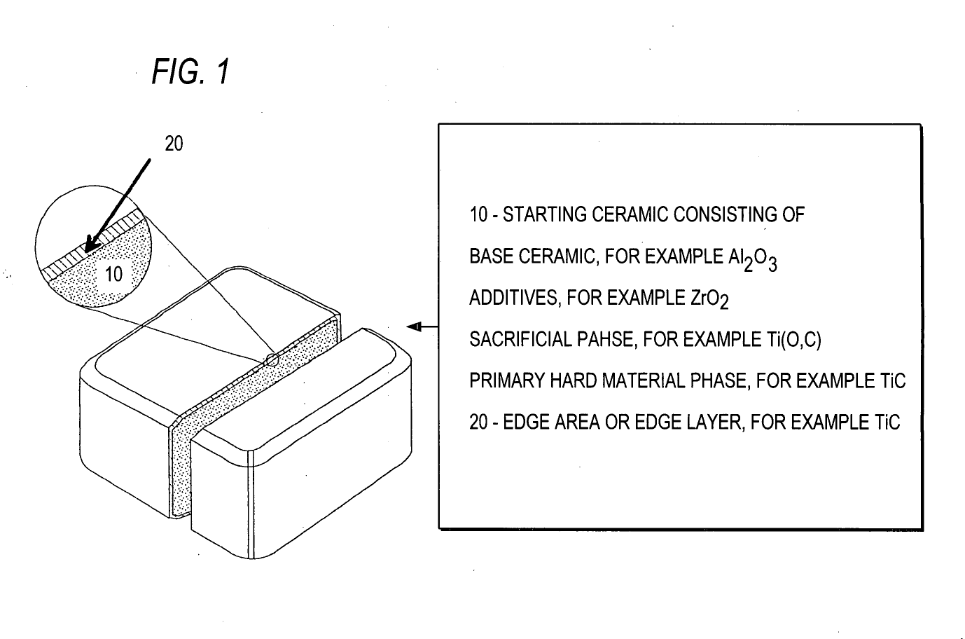

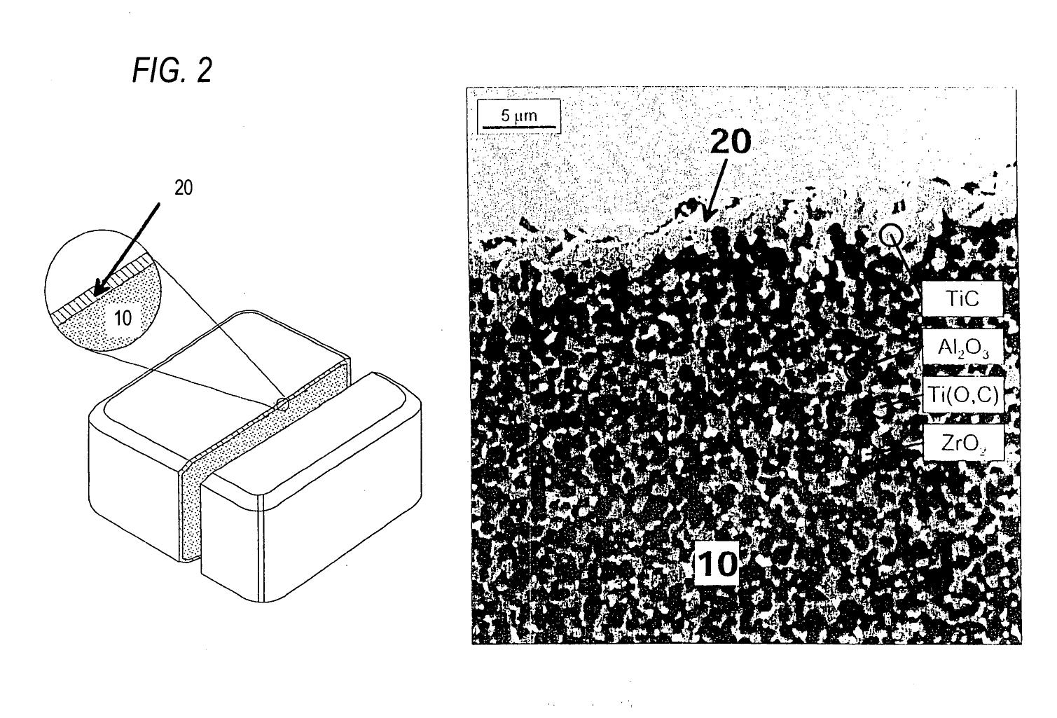

The ceramic cutting body represented in FIGS. 1 and 2 has an edge area resistant to wear 20 which does exist on the whole periphery with an increased resistance to wear. Furthermore, the phase existence of the ceramic is explained as an example in FIG. 1. FIG. 2 shows in the polished section the starting ceramic 10 made of Al₂O₃, ZrO₂ and Ti(O,C) as well as the edge area 20 characterized by a high TiC content which is intimately intergrown with the starting ceramic and which has a thickness of approximately 2-3 μm.

A technology for manufacturing such a mixed ceramic according to the invention is described below as an example.

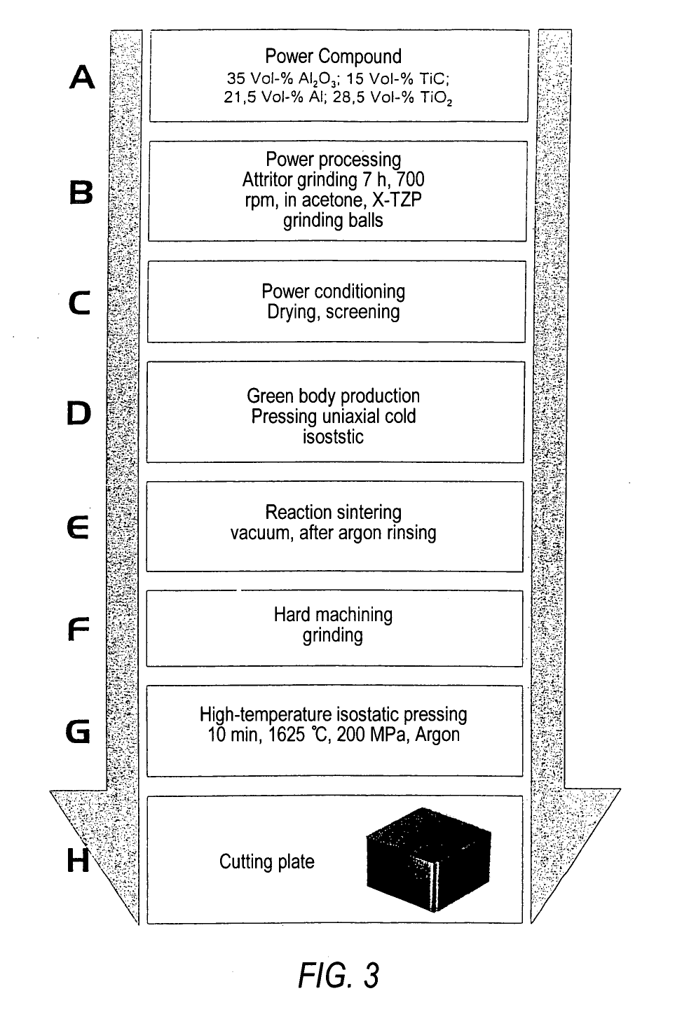

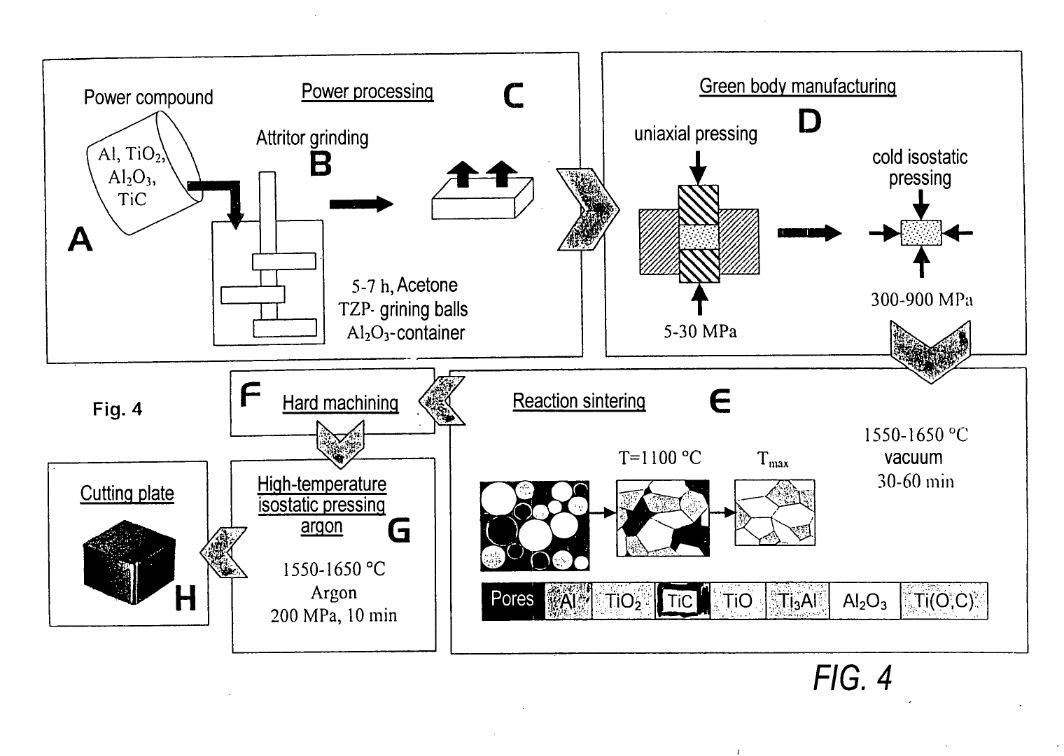

The method is first based on an exothermal reduction of a metallic oxyde by metallic aluminium under in-situ formation of Al₂O₃. Different mixed ceramics can be manufactured by adding primary ceramic hard material phases, for example TiC, Ti(C,N), TiN into the starting powder mixture. The aluminothermal manufacturing of mixed ceramics is schematically represented in the FIGS. 3 and 4. The powder formulation (A) is composed of reactive and inert constituents. The reactive constituents aluminium and TiO₂ realize the in-situ formation of Al₂O₃. However, the reaction partners are not in a stoichiometric ratio so that there does not remain any metallic titanium but a titanium mixed phase of a titanium oxycarbide or titanium oxycarbonitride is formed from the primary constituents TiO₂ as well as from the carbon of the furnace atmosphere, from the graphite heating elements of the furnace as well as from a graphite or graphite containing sintering bed which surrounds the sample as well as the optionally used primary hard material, for example TiC, Ti(C,N) or TiN.

The sintered cutting plate blanks are first preferably hard machined (F) by grinding on free face, first face and cutting edge and provided with the wished cutting edge geometry.

According to the invention, a subsequent high-temperature isostatic pressing (G) follows the hard machining as last manufacturing step.

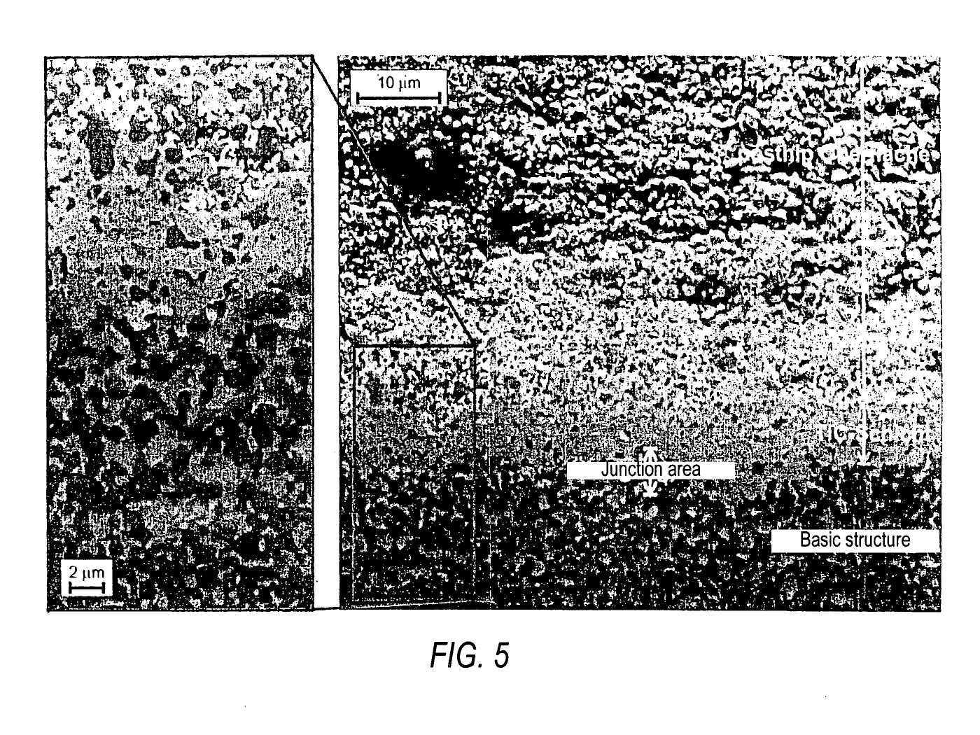

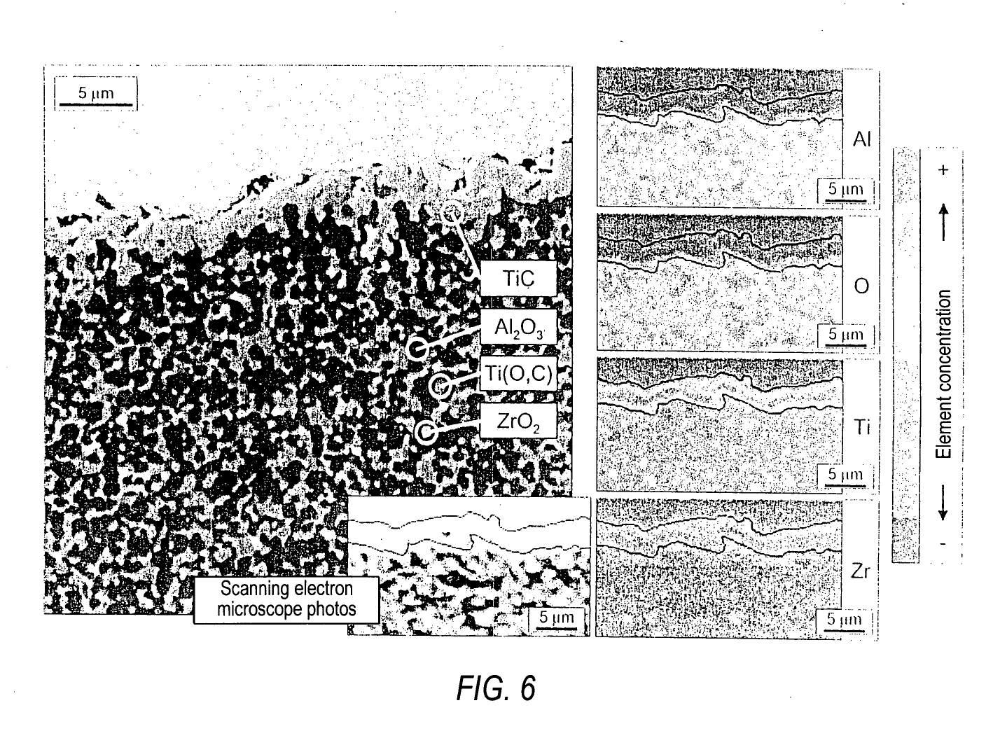

Surprisingly, edge areas of hard materials such as TiCₓ with a considerably reduced Al₂O₃ content develop—as represented in the FIGS. 5 and 6. FIG. 5 shows in the oblique polish of a cutting body the edge area 20 with a considerably reduced Al₂O₃ content compared to the basic structure 10 as well as the junction area in which basic structure and edge area are intimately intergrown. In FIG. 6, scanning electron microscope photos of an oblique polish as well as distributions of the elements Al, O, Ti and Zr are shown in the starting ceramic 10 as well as in the edge area 20. According to FIG. 6 below right, there is a layer sequence of TiCₓ and ZrCₓ, starting from the basic material in the edge area, whereby the zirconium oxyde of the way of manufacturing concretely represented in FIG. 3 originates from the abrasion of the grinding instruments or balls. In FIG. 5, the thin ZrCₓ covering layer light can be seen on the posthip surface. The formation of a TiCₓ, TiNₓ or Ti(Cₓ,N_{y})_{z} edge area takes place as a result of the structure of the aluminothermally sintered mixed ceramic as well as a reducing carbon containing atmosphere (as a result of the graphite heating elements of the furnace and/or of the graphite or graphite containing sintering bed surrounding the sample) or in a nitrogen containing atmosphere (as a result of the used rinsing or pressure gas).

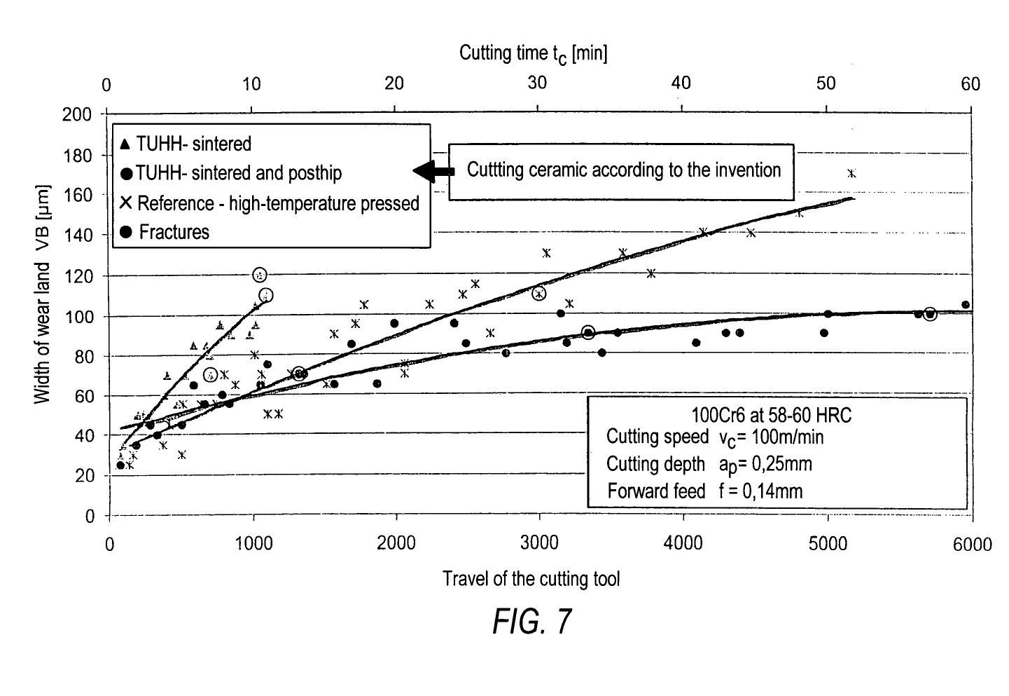

The advantageous effect of the edge area resistant to wear on the service properties appears in cutting trials compared to mixed ceramic cutting bodies according to the prior art; see FIG. 7. There results when hard turning steel 100Cr6 a considerably slowlier increase of the width of wear land which can cause the damaging of the component surface and thus which limits the service life of the cutting body.

In the case of TiN as edge area or as upper layer of a multilayer edge area, an advantageous frictional behaviour is achieved as well as a clear recognization of the wear of the edge because of the colour.

The advantage of the method for manufacturing mixed ceramic cutting materials with an edge area or an edge layer is a simple charging of the cutting bodies for producing the edge area or layer. The method makes possible a dense packing/charging of the cutting bodies for the edge area producing process. For example, the cutting bodies can be stapled directly on each other so that the diffusion reactions producing the edge areas take place only on the accessible areas near the cutting edges and consequently the edge areas are preferably configured in the area of the cutting edges.

Of course, for the further improvement of the service properties, the cutting bodies can be coated subsequently with known alternatives of the usual coating methods, for example with PVD and/or CVD.

The manufacturing of a cutting body takes place in the stages represented in FIG. 3, whereby reference is made to the respective process conditions indicated in FIG. 3 which represent an example of an embodiment. In stage A, the production of the powder compound takes place, for example of a mixture of 35% by vol. Al₂O₃, 14% by vol—TiC, 21.5% by vol. Al and 28.5% by vol. TiO₂. In stage B follows the powder processing by attritor grinding. This being, the powder compound is attrited during 7 hours at 700 rpm in acetone by means of Y-TZP grinding balls and Y-TZP grinding disks in an Al₂O₃ container. The attrited ZrO2 resulting from the use of Y-TZP grinding disks and balls can be ascertained by X-ray examinations as well as by microprobe examinations as represented in FIG. 6. The powder conditioning takes place then in stage C by drying and screening with a mesh size of 200 μm. In stage D, the basic body is produced first by uniaxial pressing at 5 MPa and then by cold isostatic pressing at 900 MPa. Stage E contains the reaction sintering in vacuum (after argon rinsing) in a graphite heated gas pressure sintering furnace, whereby the sintering programme contains the following heating rates and stay-down times:

| RT | to 300° C. | with 6 K/min |
|---|---|---|
| 300° C. | to 550° C. | with 3 K/min |
| 550° C. | to 700° C. | with 1 K/min |
| 700° C. | to 1625° C. | with 30 K/min |
| at 1625° C. | 1 hour stay-down time | |
| 1625° C. | to 575° C. | with 10 K/min and |
| 575° C. | to RT | with natural cooling. |

There follows then in stage F the hard machining by grinding and at last, according to the method according to the invention, in stage G the high-pressure isostatic pressing, in particular at 1625° C., with argon as pressure gas, in particular at 200 MPa, in a high-temperature isostatic press heated with graphite elements over a period of 10 minutes so that a ceramic cutting body with the properties mentioned above in the edge area or edge layer is obtained. FIGS. 5 and 6 represent an oblique polish of an edge area according to the invention.

The stages of the method indicated in FIG. 3 are represented as schematic sequence in FIG. 4, whereby the stage E with the reaction sintering illustrates the course of the sintering over the phase development of the starting powder. The temperature and pressure ranges indicated in the FIGS. 3 and 4 do not represent any area limitation, process conditions which differ from the indicated ranges of values are also possible; other pressure gas than those indicated can be used as well.

A further embodiment of the processes of the method for manufacturing a cutting body according to the invention according to FIGS. 3 and 4 provides a machining of the green body before the process step (E), for example by grinding the first face, free face and protection chamfer for configuring a cutting edge, whereby it can be renounced to process step (F). This makes possible to combine the process steps (E) and (G) so that process times and costs are reduced.

For a further configuration of the processes of the method for manufacturing a cutting body according to the invention, the green body is presintered in a first sintering process preferably below the planned maximal sintering temperature. This presintering takes place preferably in vacuum and in a reducing atmosphere. Then the semifinished product is hard machined by taking into account eventually still existing porosity and is dense sintered in a second sintering process at maximal temperatures in the range of 1550-1650° C. as well as with a stay-down time of 30-60 minutes in an evacuated preferably graphite heated sintering furnace and this being or afterward thermally aged in a defined atmosphere. Alternatively a high-temperature isostatic pressing follows the dense sintering in a defined atmosphere. The atmosphere is reducing, preferably carbon and/or nitrogen containing. This alternative makes possible a reduction of the hard machining costs by the geometry producing of the cutting body with a semifinished product with a lower strength whereby compared with the green body machining lower dimensional deviations, higher cutting edge qualities and a lower sensitivity of the semifinished products for the handling are achieved because of the presintering.

For a special configuration of the processes of the method for the aluminothermic manufacturing of a cutting body according to the invention, the green body is reactively presintered in a first sintering process in a temperature range of 500-800° C., preferably with a heating rate of 1 K/min between 550 and 700° C., whereby the aluminothermic reaction is at least partially or completely terminated. The semifinished product is then hard machined by taking into account the existing porosity, is subject to a second sintering process or is high-temperature isostatically pressed and, this being or afterwards, is thermally aged in a defined atmosphere.

FIG. 1
10—Starting ceramic consisting of
base ceramic, for example
additives, for example
sacrificial phase, for example
primary hard material phase, for example
20—Edge area or edge layer, for example

FIG. 3
A—Powder compound
B—Powder processing
Attritor grinding 7 h, 700 rpm, in acetone, X-TZP grinding balls
C—Powder conditioning
Drying, screening
D—Green body production
Pressing uniaxial
cold isostatic
E—Reaction sintering
vacuum, after Argon rinsing
F—Hard machining
grinding
G—High-temperature isostatic pressing
H—Cutting plate

FIG. 4
Powder processing
A Powder compound
B Attritor grinding
Acetone, grining balls, container
C Drying/screening
D Green body manufacturing
uniaxial pressing
cold isostatic pressing
E Reaction sintering
vacuum
pores
F Hard machining
G High-temperature isostatic pressing argon
H Cutting plate

FIG. 5
Junction area
Basic structure

FIG. 6
Scanning electron microscope photos
Element concentration

FIG. 7
Cutting time
Width of wear land
Travel of the cutting tool
sintered
reference—high-temperature pressed
Fractures
Cutting ceramic according to the invention
Cutting speed
Cutting depth
Forward feed

1. Ceramic cutting tool with an improved resistance to wear of the edge area or edge layer,
characterized in
that the cutting tool is a multiphase ceramic (starting ceramic) which is made of a base ceramic and a sacrificial phase as well as eventually additives and primary hard material phases and an eventually multilayered edge area or edge layer resistant to wear, hard, not precipitated, made of at least one hard material phase, whereby the edge area is intimately intergrown with the starting ceramic and which is formed by aging the starting ceramic in a defined atmosphere.

2. Cutting tool according to claim 1,
characterized in
that the starting ceramic consists of a sacrificial phase with 50% by volume at the most and eventually additives with 40% by volume at the most and eventually a primary hard material phase with 50% by volume at the most, the rest base ceramic.

3. Cutting tool according to any of the claims 1 and 2,
characterized in
that the base ceramic consists of Al₂O₃.

4. Cutting tool according to any of the claims 1 to 3,
characterized in
that the sacrificial phase consists of the oxyde and/or an oxygen containing compound of carbon and/or nitrogen and/or boron, of one or several characteristic elements, especially of titanium oxyde and/or titanium oxycarbide and/or titanium oxynitride and/or titanium oxycarbonitride.

5. Cutting tool according to any of the claims 1 to 4,
characterized in
the characteristic elements are elements of the 3^{rd} or the 4^{th} or the 5^{th} period, of the subsidiary group IV or V or VI of the system of the period of the elements and/or boron and/or silicium, preferably titanium and/or zirconium and/or vanadium and/or tungstene and/or boron and/or silicium, especially titanium and/or zirconium.

6. Cutting tool according to any of the claims 1 to 5,
characterized in
that zirconium oxyde is used as additive.

7. Cutting tool according to any of the claims 1 to 6,
characterized in
that the primary hard material phase is the carbide and/or nitride and/or boride and/or carbonitride and/or carboboride and/or boron nitride and/or carboboron nitride of one or of several characteristic elements, preferably titanium carbide and/or titanium carbonitride, especially titanium carbide.

8. Cutting tool according to any of the claims 1 to 7,
characterized in
that the edge area or edge layer consists mainly of carbides and/or nitrides and/or borides and/or the mixtures thereof of one or of several characteristic elements and has a thickness between 0.1 μm and 20 μm, preferably between 0.5 μm and 8 μm, especially between 1 μm and 4 μm.

9. Cutting tool according to any of the claims 1 to 8,
characterized in
that a junction area of between 50 nm and 5 μm is formed between the edge area and the starting material, junction area in which they are intimately intergrown.

10. Cutting tool according to any of the claims 1 to 9,
characterized in
that the structure of the multiphase ceramic has a mean grain size between 100 nm and 10 μm, preferably between 300 nm and 5 μm, in particular between 500 nm and 3 μm.

11. Cutting tool according to any of the claims 1 to 10,
characterized in
that the sacrificial phase consists of titanium oxycarbide and has a lower nanohardness than Al₂O₃ (measured with Berkovichindenter, at 3 mN), at the most 26 GPa, preferably 23 GPa.

12. Cutting tool according to any of the claims 1 to 11,
characterized in
that the edge area or edge layer mainly consists in particular of titanium carbide which has a higher nanohardness than Al₂O₃ (measured with Berkovichindenter, at 3 mN), preferably in the range between 27 GPa and 35 GPa, in particular 29 GPa to 32 GPa.

13. Cutting tool according to any of the claims 1 to 12,
characterized in
that an one-layer or multilayer coating is applied onto the edge area or edge area by means of physical and/or chemical precipitation of the same and/or of different materials, whereby the service properties of the cutting tool are improved.

14. Method for manufacturing a cutting tool with an improved resistance to wear of the edge area or edge layer according to any of the claims 1 to 13,
characterized in
that the method comprises the following steps:
According to known powder metallurgical methods, the starting powders are processed, green bodies manufactured and compacted to semifinished products with known sintering methods;
Manufacturing of the wished cutting edge geometry, preferably by grinding, in particular of the first face, free face and protection chamfer;
Production of edge areas or edge layers after the hard machining of the cutting tool by subsequent aging in a defined atmosphere.

15. Method for manufacturing a cutting tool with an improved resistance to wear of the edge area or edge layer according to any of the claims 1 to 13,
characterized in
that the method comprises the following steps:
According to known powder metallurgical methods, the starting powders are processed, green bodies manufactured and compacted to semifinished products with known sintering methods;
Manufacturing of the wished cutting edge geometry, preferably by grinding, in particular of the first face, free face and protection chamfer;
Production of edge areas or edge layers after the hard machining of the cutting tool by subsequent aging in a defined atmosphere.

16. Method for manufacturing a cutting tool with an improved resistance to wear of the edge area or edge layer according to any of the claims 1 to 13,
characterized in
a multiphase starting ceramic/starting material is made available which consists of a sacrificial phase of at the most 50% by volume and at the most 40% by volume additives and at the most 50% by volume primary hard material phase and the rest base ceramic, whereby
after the powder processing a green body manufacturing takes place with a subsequent reaction sintering,
then a hard machining of the sintered ceramic body, preferably by grinding, in particular of the first face, protection chamfer and free face, is carried out and
after the hard machining of the ceramic cutting body a thermal, preferably thermally pressure-assisted aging in a reducing, preferably in a carbon and/or nitrogen containing atmosphere, specially a high-pressure isostatic pressing, preferably at 1550°-1650° C. or at other appropriate temperatures for producing an edge area or edge layer on a multiphase, preferably on Al₂O₃ based ceramic.

17. Method for manufacturing a cutting tool with an improved resistance to wear of the edge area or edge layer according to any of the claims 1 to 13,
characterized in
that the method comprises the following steps:
After the known powder metallurgical methods, the starting powder is processed and green bodies are manufactured; preferably the composition of the starting powders is chosen with respect to a reaction sintering, in particular with respect to an aluminothermic reaction sintering;
Presintering of the green body preferably below the foreseen maximal sintering temperature, preferably in the temperature range of 200° and 1500° C., in particular 300 and 800° C., preferably at a pressure between 0.001 mbar and 1 bar, in particular between 0.01 mbar and 100 mbar, preferably by using a rinsing gas, in particular argon, preferably in a defined atmosphere, preferably in a reducing, in particular in a carbon containing atmosphere.
Machining of the presintered cutting body for manufacturing the wished cutting edge geometry, preferably by grinding, in particular of the free face and/or the protection chamfer and/or the first face;
Second sintering or dense sintering of the presintered and hard machined semifinished product with simultaneous or subsequent aging in a defined atmosphere for producing an edge area or edge layer.

18. Method according to any of the claims 14 to 17,
characterized in
that the sintering or presintering and/or the second sintering of the ceramic cutting body takes place by means of aluminothermic or reactive or conventional depressurized, eventually vacuum-assisted sintering and/or by means of high-temperature isostatic pressing and/or hot pressing and/or microwave sintering and/or laser sintering.

19. Method according to any of the claims 14 to 18,
characterized in
that the edge are is formed by thermal, eventually pressure-assisted aging (or sintering according to claim 17) of the cutting body.

20. Method according to any of the claims 14 to 19,
characterized in
that the edge area is formed by aging in a defined, preferably reducing, in particular in a carbon containing atmosphere, preferably in a furnace with carbon or carbon containing heating elements.

21. Method according to any of the claims 14 to 20,
characterized in
that the edge area is formed by aging in a defined, preferably reducing, in particular in a carbon containing atmosphere, in particular in a nitrogen containing atmosphere.

22. Method according to any of the claims 14 to 21,
characterized in
the edge area is formed by aging at maximal temperatures between 1000° C. and 2500° C., preferably between 1300° C. and 2000° C., in particular between 1550° and 1650° C.

23. Method according to any of the claims 14 to 22,
characterized in
that the edge area is formed by thermal or thermally pressure-assisted aging at a pressure of between 0.001 mbar and 4000 bar, preferably at a pressure between 100 bar and 3000 bar.

24. Method according to any of the claims 14 to 23,
characterized in
the edge area is formed by aging by using rinsing and/or pressure gas, preferably argon and/or nitrogen, in particular argon.

25. Method according to any of the claims 14 to 24,
characterized in
the edge area is formed by aging at stay-down times between 1 min and 300 min, preferably between 5 min and 180 min, in particular between 10 min and 60 min, at a pressure chose according to claim 23 and/or at a temperature chosen according to claim 22.

26. Method according to any of the claims 14 to 25,
characterized in
that the aging takes place in a sintering bed, preferably in a carbon containing sintering bed.

27. Method according to any of the claims 14 to 26,
characterized in
that due to the aging an externally discoloured edge area, preferably an at the surface gold yellow edge area is produced.

28. Use of a ceramic cutting tool with an improved resistance to wear of the edge area or edge layer produced by aging of the ceramic starting material as part according to any of the claims 1 to 13 in apparatus and mechanical engineering, in particular as cutting body, which is used for the machining of metallic materials with a hardness higher than 50 HRC, preferably of hardened steel or materials for casting, whereby the cutting body has a first face and a free face and an cutting edge formed at the junction of the first face and of the free face which is preferably chamferred (protection chamfer).
